(19) United States
(12) Patent Application Publication
(10) Pub. No.: US 2002/0002589 A1
(43) Pub. Date: Jan. 3, 2002

(54) Method and system for managing access right of E-mail information

(76) Inventors: Tomomi Yonenaga, Yokohama (JP); Kazuya Koutani, Yachiyo (JP); Hideko Kagimasa, Yokohama (JP); Katsumi Tada, Kawasaki (JP)

Correspondence Address: MATTINGLY, STANGER & MALUR, P.C., 104 EAST HUME AVENUE, ALEXANDRIA, VA, 22301, US

(21) Appl. No.: 09/793,597

(22) Filed: Feb. 27, 2001

(30) Foreign Application Priority Data
Jun. 21, 2000 (JP) 2000-185799

(51) Int. Cl. G06F 15/16

(52) U.S. Cl. 709/206; 709/200

(57) ABSTRACT

In a system for registering and managing the E-mail information that is necessarily used commonly by a plurality of users/groups professionally, a group of a plurality of user information including addressers and addressees who relate to the transmission/reception is extracted from the E-mail information to be registered, and the user information is stored in an access right group management information corresponding to the E-mail information as a user group who deserves the common access right. Thereby, the necessary access right is set to each E-mail information easily and correctly. When a user requests an access to the E-mail information, the access right group management information is referred to thereby determine whether there is the access right or not. Thereby, the invention provides a method for managing the access right of E-mail information that is useful to set the complex management operation of the access right, that is to be used commonly between addressers and addressees, of the E-mail information to be used commonly by members of an organization.

### BACKGROUND OF THE INVENTION

This invention relates to a method and a system for managing access right for storing and managing E-mail information.

The E-mail system has been widely used as a communication tool for conversation like the telephone system. Recently, a decision making method in which a document is electronically prepared by use of a personal computer and an OA software and the information is communicated by means of the E-mail system has been established. The E-mail information that is important as the business activity record has been accumulated, and it becomes important that the E-mail information is used by the organization in common.

Because the E-mail system is served for transmission and or reception usually, the E-mail information is managed in personal unit in a server, and the important E-mail information that should be used commonly by an organization is not managed in organizational unit that is suitable for the organizational management system. Furthermore, because the E-mail system can beused for personal purpose in addition to organizational purpose, a method in which the necessary E-mail information is selectively stored in an external recording medium and the selected E-mail information is managed separately is suitably used. In the case that the E-mail information selected and stored as described hereinabove is referred directly or used by a plurality of users of the organization, it is necessary to manage the access right so that the E-mail information is used by limited users.

As the method for recording and storing the E-mail information for organizational common use, a method in which the E-mail information is commonly used by means of the log management function of the mailing list and a method in which the E-mail information is commonly used by means of registration in the document management system have been known.

### SUMMARY OF THE INVENTION

However, each of these methods has its merits and demerits but cannot realize the following functions in the case that the access right is managed so that users who are involved in transmission and or reception of the E-mail information commonly use the E-mail information.

At first, in the method in which the E-mail information is used commonly by use of the log management function of the mailing list, each of all the users who are mailing list members uses the E-mail information equally as one member of the information common use group without personal discrimination. Therefore, because the set range of the information common use is fixed from the view of the user side of the mailing list, it is impossible to use the information limitedly to arbitrary partial members as required.

Next, in the method in which the E-mail information stored in a document management system is used commonly, it is possible to set the access right for each addresser or addressee in the individual E-mail information unit for common use. “Access right determination system” (Japanese Unexamined Patent Publication No. Hei 5-88960) and “Access right management system” (Japanese Unexamined Patent Publication No. Hei 7-244639) have been known as the typical example of such access right management function. However, it is required for users to register, and the setting operation of the access right for common use of the E-mail information between users who are involved in transmission and or reception of the E-mail information is very complex. Because the addressee registers the E-mail information and sets the access right, the setting can be different from that the addresser wants to have. The mis-setting, namely registration without setting of the access right, can occur.

It is an object of the present invention to provides a method, a system, and a recording medium for managing the access right of the E-mail information that are served for setting the complex access right management operation for common use of the E-mail information between addressers and addressees of the E-mail information to be used by the organization easily and correctly.

To achieve the above-mentioned object, in the present invention, a method for managing access right of E-mail information used in the system in which the E-mail information is registered and managed in a storage means comprises a step in which the user information that relates to transmission and or reception is extracted from the E-mail information of registration management target, and a step in which an access right is set to the E-mail information of the registration management target based on the user information.

Furthermore, the method additionally comprises a step in which the E-mail information to be transmitted and or received is acquired from the E-mail system and transferred to the storage means, and the user information that relates to transmission and or reception is extracted from the E-mail information transferred in the above step.

### BRIEF DESCRIPTION OF THE DRAWINGS

FIG. 1 is a system structure block diagram of a first embodiment of the present invention.

FIG. 2 is a diagram illustrating an example of an access right common use group in the access right group management information.

FIG. 3 is a flow chart for describing the access right setting in registration of the E-mail information of the first embodiment.

FIG. 4 is a system structure block diagram of a second embodiment of the present invention.

FIG. 5 is a system structure block diagram of a third embodiment of the present invention.

FIG. 6 is a system structure block diagram of a fourth embodiment of the present invention.

FIG. 7 is a diagram illustrating an example of the access right common use group in the access right common use group in the fourth embodiment.

FIG. 8 is a flow chart for describing the access right setting in registration of the E-mail information of the fourth embodiment.

FIG. 9 is a system structure block diagram of a fifth embodiment of the present invention.

FIG. 10 is a diagram illustrating an example of the access right common use group in the fifth embodiment.

FIG. 11 is a flow chart of the access right setting in registration of the E-mail information of the fifth embodiment.

### DETAILED DESCRIPTION OF THE PREFERRED EMBODIMENTS

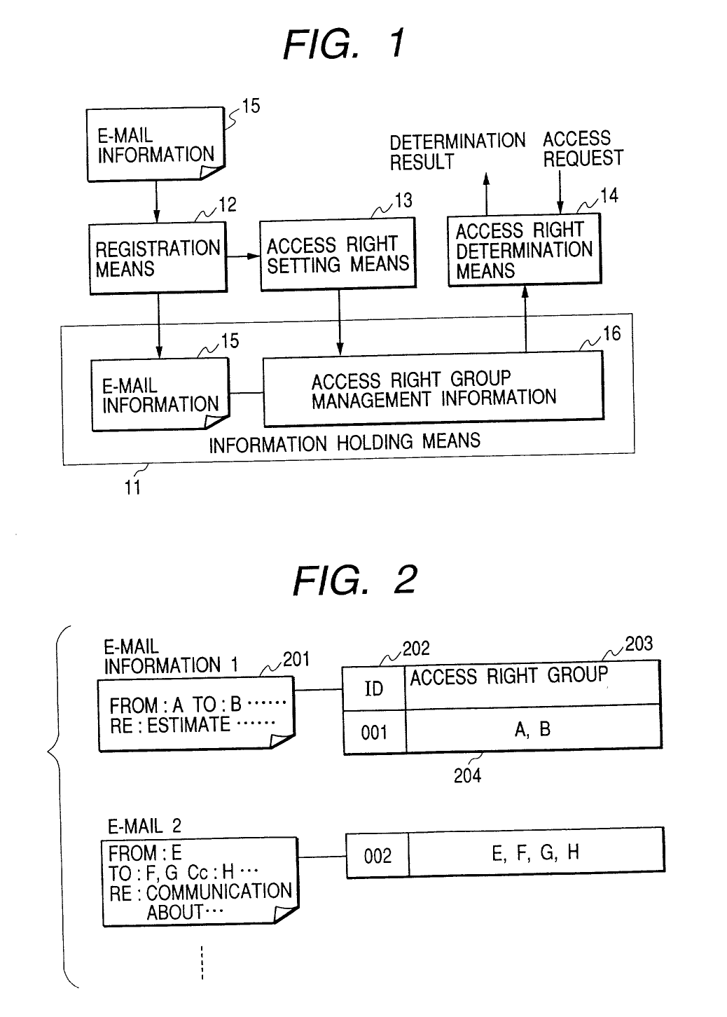

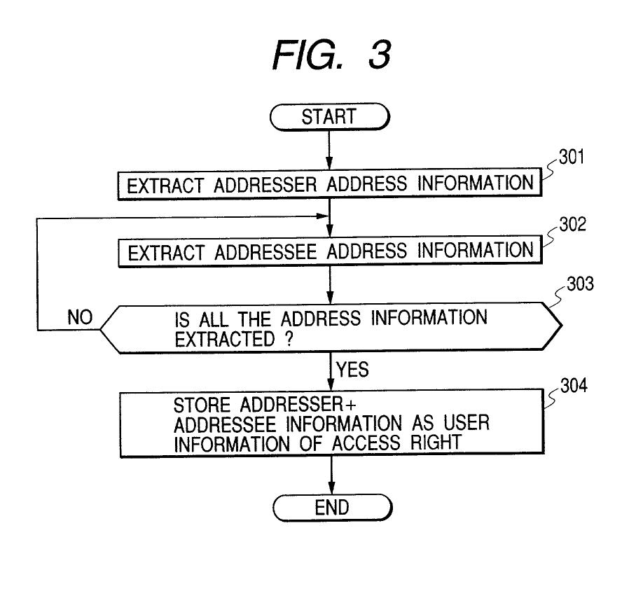

The preferred embodiments of the present invention will be described hereinafter with reference to the drawings. At first, a first embodiment will be described herein with respect to FIG. 1, FIG. 2, and FIG. 3. In the present embodiment, an access right management method in which the E-mail information taken out from the E-mail system and stored in a separate recording means is used by a plurality of users who are involved in the transmission and or reception of the E-mail information will be described.

FIG. 1 is a block diagram illustrating the system structure of the first embodiment to which the access right management method of the present invention is applied. At first, structural components are described. The system of the present embodiment is provided with an information holding means or program 11, a registration means or program 12, an access right setting means or program 13, and an access right determination means or program 14.

The information holding means 11 stores and holds the E-mail information 15 supplied through the registration means or program 12. The information holding means 11 includes a data base, a file system, a system apparatus for storing these database and files, and a recording medium. The E-mail information 15 and the access right group management information 16 are stored in the information holding means 11. The E-mail information 15 is the information that is transmitted and or received between a plurality of users who are registered in the usual E-mail system. On the other hand, the access right group management information 16 is the information that includes the user information served to permit or inhibit the access to the E-mail information 15. It is assumed that the access right group management information 16 corresponds to the E-mail information 15 individually.

The access right setting means or program 13 is activated to set the access right to the access right group management information concomitantly when the registration means or program 12 stores the E-mail information 15 in the information holding means 11. The access right determination means or program 14 refers to the user information stored in the access right group management information 16, determines whether there is the access right of the access requester or not, and returns the determination result to the access requester when the access request occurs in the E-mail information 15.

An example of the information stored in the access right group management information 16 shown in FIG. 1 is described with reference to FIG. 2. FIG. 2 shows a storage model example for describing the management of the E-mail information 15 and the access right group management information 16 in the information holding means 11. The ID 202 and the access right group 203 are stored correspondingly to the E-mail information 201. The E-mail information 201 is the entity of the individual E-mail information as shown exemplary in FIG. 2. The ID 201 is the information (identifier) for identifying the E-mail information. The access right group 203 is the information that is formed by storing and grouping the user information for permitting the access to the E-mail information 201. The access right group 203 is one-to-one correlated to each E-mail information, and manages the group of user information having the access right commonly.

Next, a routine for setting the access right concomitantly or accompanying with registration of the E-mail information is described with reference to FIG. or 13. The flow chart of FIG. 3 shows the routine that is implemented by means of the access right setting means or program 13. In the present embodiment, the registration means or program 12 registers one E-mail information each time when one E-mail information is indicated to be registered, and the processing shown in FIG. 3 is started when the registration means or program 12 activates the access right setting means or program 13. Furthermore, the address information of the E-mail is used as the user information of the access requester. As an example of the E-mail information common use method in the present embodiment, the routine for the case in which the E-mail information is used by all the members including addresser [From:] users and addressee [To:, Cc:] users will be described. As a matter of course, arbitrary access right determination rule is selectable, for example, the E-mail information is commonly used only by a user group having the addresser [From:] address or having the addressee [To:, Cc:, Bcc:] address, only by a combined user group of From:, To:, Cc:, and Bcc: addresses, or by a user group of the discriminated access right level.

At first, the address information of an addresser is extracted from the From: part of the header information of the E-mail information 15 (step 301). Subsequently, one address information is extracted from To: and Co: part of the header information of the E-mail information 15 (step 302). Then, the step 302 is repeated until the address information of all the addressees is extracted (step 303). The taken out address information of the addresser and all the addressees is stored in the access right group management information 16 as the user information that indicates whether there is the access right or not (step 304).

An detailed example in which the access right determination means or program 14 determines the access request by use of the information stored in the table shown in FIG. 2 and the above-mentioned process result is described herein under. As shown in 204 in FIG. 2, wherein “A” denotes the addresser address information and “B” denotes the addressee address information of the E-mail information 1, the address information “A and B” is stored as the user having the right in the access right group 203. In this case, only the users “A and B” are allowed to have the access to the E-mail information 1 through the access right determination means or program 14.

As described hereinabove, according to the present embodiment, the E-mail information can be commonly used by the user who transmits and or receives the E-mail information.

Furthermore, according to the present embodiment, in the case that the E-mail information is used only by users who are involved in transmission and or reception of the E-mail information, the operational load required for setting the access right is omitted and the access right is set easily. On the other hand, in the prior art, in the case that the access right is set when the E-mail information is stored in a document management system, the complex operation in which a plurality of user information is selected each time when one E-mail information is registered and the access right is assigned to the selected users should be performed so that the E-mail information is used commonly only by users who are involved in transmission and or reception of the E-mail information. The reason is that the user group including an addresser of one E-mail information and a plurality of addressees cannot be specified because the addresser can select addressees arbitrarily for each transmission in the case of the E-mail system and the combination of the addresser and the addressees is changed constantly.

Furthermore, according to the present embodiment, because the access right is set every time according to the right setting rule that has been determined previously when the E-mail information is registered, mis-setting operation is prevented and the access right is set correctly.

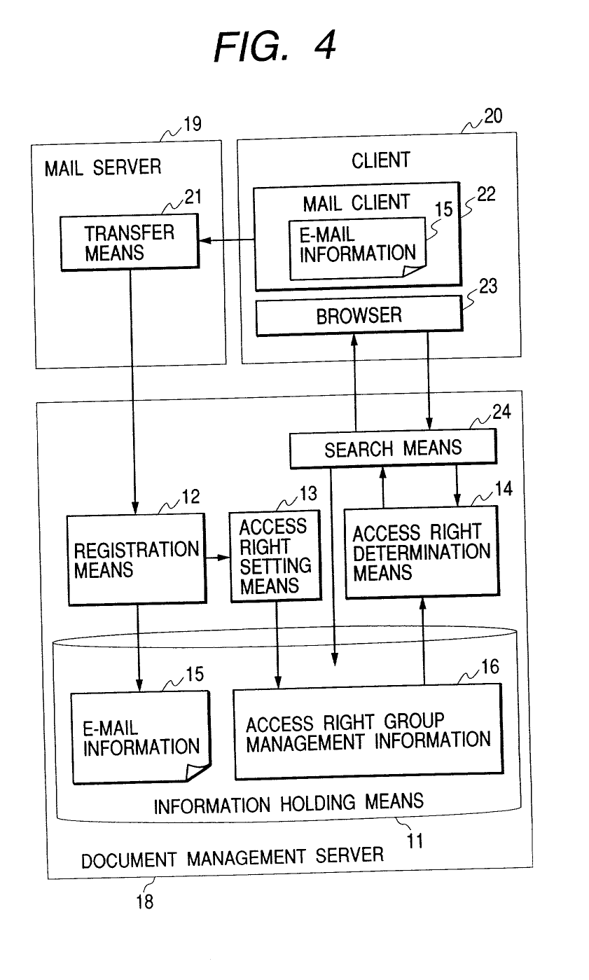

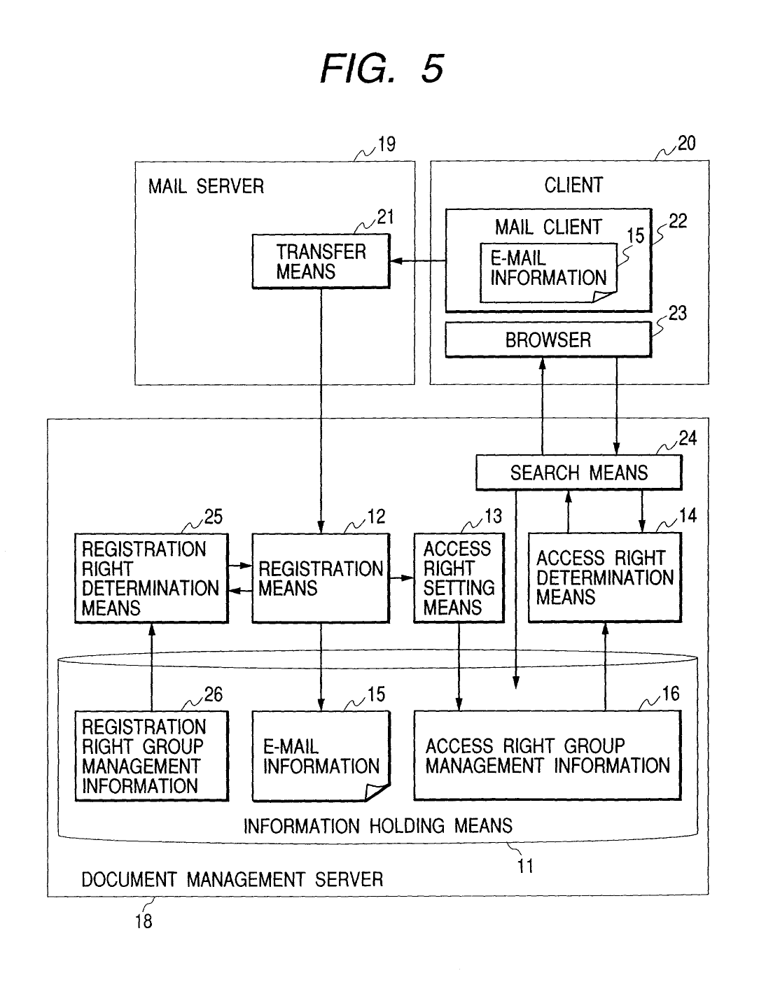

Next, a second embodiment of the present invention will be described hereinafter with reference to FIG. 4. In the first embodiment, when, for example, a management user indicates that the E-mail information is registered in the information holding means, the registration means or program 12 registers the E-mail information and the access right is set automatically at that time. However, in the case that the E-mail information to be involved increases, it is troublesome and time-consuming for a management user to perform registration operation of a lot of E-mail information that is generated successively. To solve such problem, in the second embodiment, an example of the access right managing method in which registration and access right setting are automatically carried out with linking to transmission of the E-mail information will be described herein under.

FIG. 4 shows a system structure of the second embodiment. The structural components of the second embodiment shown in FIG. 4 are basically the same as those of the first embodiment shown in FIG. 1. The same structural components used in FIG. 4 as shown in FIG. 1 are given the same characters or numerals numbers as shown in FIG. 1. In the second embodiment shown in FIG. 4, the following structural components are added to the first embodiment shown in FIG. 1.

The second embodiment is provided with a document management server 18 comprising the components used in the first embodiment, a mail server 19, and a client 20. The document management server 18 has a search means or program 24 in addition to the structural components of the first embodiment. The mail server 19 has a transfer means or program 21. The client 20 has a mail client 22 and a browser 23. The mail client 22 communicates the E-mail information with the mail server 19. The transfer means or program 21 transmits the E-mail information to the registration means or program 12 of the document management server 18 synchronously with reception of the E-mail information transmitted from the mail client 22. Upon receiving the E-mail information 15, the registration means or program 12 of the document management server 18 starts to register the E-mail information 15. The browser 23 refers the E-mail information 15 through the search means 24 of the document management server 18. An example of the browser 23 includes the Internet Web browser, the client application of the database, the file management application of the file system, or the online virtual terminal.

Subsequently, the outline of the processing for setting the access right in registration of the E-mail information of the present invention will be described with reference to FIG. 4. At first, a user carries out mail transmission operation by use of the client 20. With this operation as a trigger, the mail client 22 of the client 20 transmits the E-mail information to the mail server 19. When the mail sever 19 receives the E-mail information 15, the transfer means or program 21 transmits the E-mail information to the registration means or program 12 of the document management server 18. When the registration means or program 12 receives the E-mail information 15, the registration means or program 12 stores the E-mail information 15 in the information holding means 11 and calls the access right setting means or program 13. The access right setting means or program 13 stores the user information that has been extracted from the E-mail information 15 in the same manner as used in the first embodiment in the access right group management information 16. Thereby, the E-mail information is registered every time when a user carries out mail transmission operation and the access right of the E-mail information is set without troublesome work of the user.

Next, the outline of the access right determination processing in the present embodiment will be described. A user carries out referring operation to the E-mail information by use of the browser 23 from an arbitrary client 20. With this operation as a trigger, the browser 23 requests an access to the access right determination means or program 14 through the search means or program 24. The access right determination means or program 14 receives the access request regarding the user as the user of the browser 23, and refers to the access right group management information 16 corresponding to the E-mail information 15 that is specified as the access target. The access right determination means 14 compares the user who requested the access with the user information stored in the access right group management information 16 and returns the determination result that indicates whether there is the right or not to the access requester. If the user who requested the access has the access right to the E-mail information 15, then the access is possible, but on the other hand if the user has no access right to the E-mail information, then the access is impossible. Thereby, only the users who are involved in transmission and or reception of the E-mail can have the access.

As described hereinabove, according to the present invention, it is possible to omit the access right registration operation that is to be carried out by the user by use of the transfer means or program 21 and the registration means or program 12 of the E-mail system.

Subsequently, a third embodiment of the present invention will be described with reference to FIG. 5.

The third embodiment is a modified example of the second embodiment. In the second embodiment is not described a method for determining whether there is registration right of the user who transmits the E-mail information or not when the E-mail information is registered by use of the transfer means or program 21 and the registration means or program 12 is not described in the second embodiment. In the present embodiment, an example of the access right management method for preventing an undeserved or not permitted E-mail user from being registered will be described herein under.

FIG. 5 shows the system structure of the third embodiment. The system structure components shown in FIG. 5 are the same basically as those of the second embodiment shown in FIG. 4. The same structural components shown in FIG. 5 as used in FIG. 4 are given the same characters as or numerals shown in FIG. 4. The third embodiment shown in FIG. 5 has the following structural components in addition to those of the second embodiment shown in FIG. 4. In detail, a registration right determination means or program 25 is added in the document management server 18, and a registration right group management information 26 is added in the information holding means 11 of the document management server 18. Before the registration means or program 12 executes the registration of the E-mail information, the registration right determination means or program 25 that has been called and executes the processing. The user information of the user who is allowed to be registered or prevented from being registered is stored previously in the registration right group management information 26.

Subsequently, the outline of the access right setting processing in registration of the E-mail information of the present embodiment will be described with reference to FIG. 5. With the mail transmission operation of a user as the trigger, the registration means or program 12 receives the E-mail information 15 by way of the E-mail server 19.

The registration right determination means or program 25 that has been called before the registration means or program 12 stores the E-mail information 15 extracts the user information of the E-mail information 15, and compares the extracted user information of the E-mail with the user information stored in the registration right group management information 26. Whether or not there is the access right of the user information, namely the addresser address information of the E-mail information to be registered is determined, and if there is the right, then the processing is executed, on the other hand if there is no right, then the processing is brought to an end. Thereby, when a user who has no registration right among E-mail users transmits E-mail information, the registration of the E-mail information is interrupted. Then, the E-mail information is returned to the addresser, and the interruption of registration is informed.

As described hereinabove, according to the present embodiment, the E-mail information of an undeserved or not permitted E-mail user is prevented from being registered.

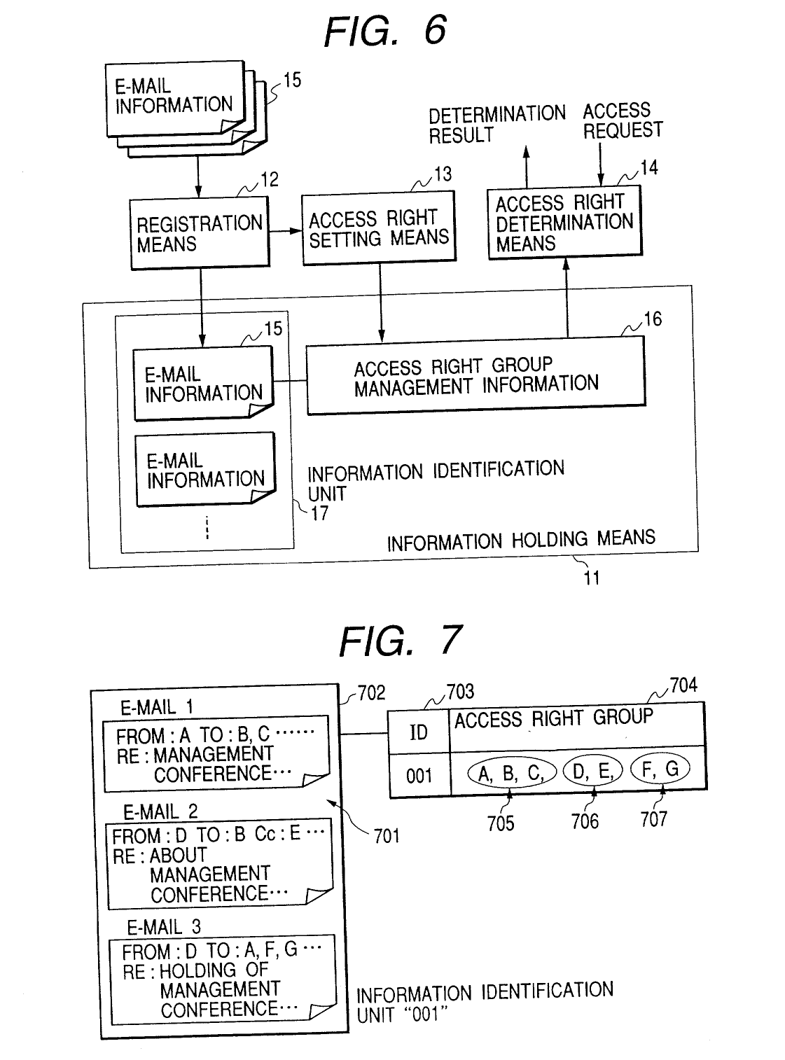

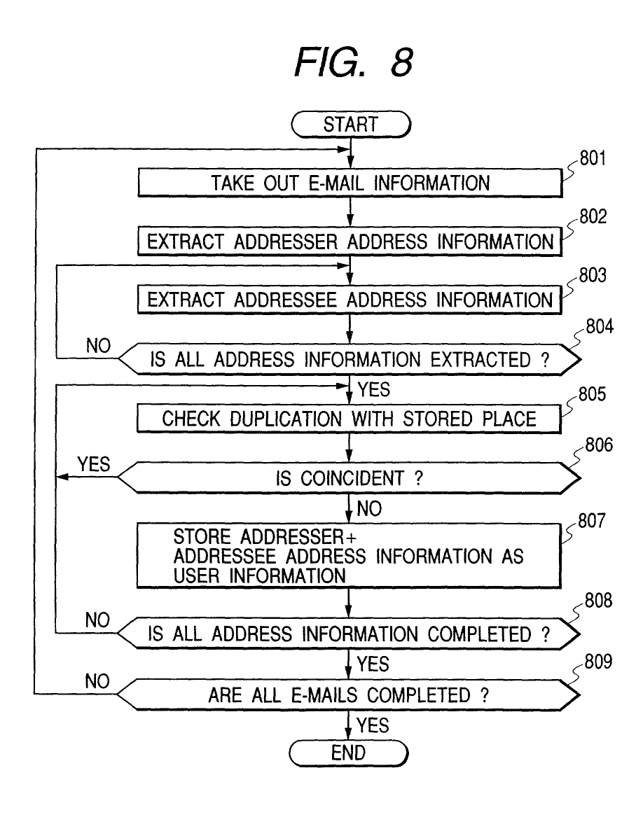

Subsequently, a fourth embodiment will be described hereinafter with reference to FIG. 6, FIG. 7, and FIG. 8.

In the first embodiment, a method in which only the addresser and addressees commonly use the access right for each E-mail information is described. It is required that all the users included in the E-mail information in a grouped unit use all the E-mail information in a folder in the case that addressers and addressees store the different E-mail information in grouped unit such as folder in a recording unit. A method in which a plurality of E-mail information is registered in one grouped unit and all the E-mail information is used commonly is not described in the first embodiment. An access right management method in which all the users, each of whom is involved in transmission and or reception of any E-mail, commonly use the E-mail information will be described in the present embodiment.

FIG. 6 is a block diagram illustrating the system structure of the fourth embodiment. The same system structural components as used in the first embodiment shown in FIG. 1 are used basically. Only the different point is described. In the present embodiment, a plurality of E-mail information 15 is managed as a grouped E-mail information by use of the information identification unit 17. The fourth embodiment is different from the previous embodiments in that the access right is set for each above-mentioned information identification unit 17. The information identification unit 17 is the classification for grouping the E-mail information according to the information obtained by identifying the attribute information or part of a character string or for grouping the E-mail information according to the hierarchy or type of the folder. The access right group management information 16 stores the user information served for determining whether there is the right or not for each information identification unit 17.

An example of the information stored in the information holding means 11 shown FIG. 6 is described with reference to FIG. 7. FIG. 7 shows a storage model example of the information stored in the information holding means 11. A plurality of E-mail information 701 shown in FIG. 7 is a group of E-mail information that is classified according to the related content. In the example shown in FIG. 7, the E-mail information that includes “management conference” in the title is grouped into one group, but the E-mail information may be classified according to the keyword included in the text of the mail, or may be classified according to the theme that is involved directly or indirectly in the E-mail information based on the determination by a user collected from the database or mail software that is used for managing all E-mail information. Numeral 702 is an example in which a plurality of E-mail information 701 is stored in the information identification unit 17 as one group. ID 703 and the access right group 704 show an example in which the E-mail information is managed by the access right group management information 16. In the example shown in FIG. 7, the identification ID for each information identification unit 702 is stored in the ID 703, and the user information for indicating whether there is the access right to all the E-mail information in the information identification unit 702 or not is stored in the access right group 704.

A routine for setting the access right concomitantly with registration of the E-mail information will be described with reference to FIG. 8. In the present embodiment, each time when a plurality of E-mail information is indicated to be registered, the registration means or program 12 registers it and the registration means or program 12 activates the access right setting means or program 13 to thereby start the routine shown in FIG. 8. Furthermore, in the present embodiment, the address information of the E-mail information is used as the user information of the access requester.

At first, the first E-mail information is taken out from a plurality of E-mail information that is indicated to be registered (step 801). Then, the address information of the addresser is extracted from the From: part of the header information of the E-mail information 15 (step 802).

Subsequently, one address information of the addressee is extracted from the To: and Cc: part of the header information of the E-mail information 15 (step 803). Subsequently, the step 803 is repeated until the address information of all the addressees is extracted (step 804).

Subsequently, the address information of the addresser taken out from one E-mail information and one addressee taken out form all the addressees are compared with the user information that has been already stored in the access right group management information 16 (step 805). If the address information has been already stored, then the routine returns to step 805 for doing comparison with the next user information, on the other hand if the address information has not been stored, then the routine proceeds to step 807 (step 806). The above-mentioned address information is stored in the access right group 704 of the access right group management information 16 (step 807). The routine is continued until all the address information in one E-mail information is processed completely with returning to step 805 (step 808). The routine returns to step 801 to take out the next E-mail information continuously until all the E-mail information is processed completely (step 809).

The detailed example in which the access right determination means or program 14 determines the access request will be described by use of the information storage example shown in FIG. 7 and the above-mentioned processing result. The example of a plurality of E-mail information of 701 shown in FIG. 7 represents an example in which every user is involved in transmission and or reception of at least any of the collected E-mail information but no user is involved in transmission and or reception of all the collected E-mail information. By applying the routine of the present embodiment to a plurality of E-mail information, the user information that indicates whether there is the access right or not is stored in the access right group 704. At first, the access right setting means or program 13 stores the address information of the addresser and the address information of the addressees “A, B, and C” of the E-mail information 1 of 705 shown in FIG. 7 in the access right group 704 as the user information concomitantly with registration of the E-mail information 1 of 701 shown in FIG. 7. Subsequently in the following, the users “D and E”, who are not yet registered, are stored as shown in 706 of FIG. 7 when the E-mail information 2 is processed. Furthermore, the users “F and G” are stored as shown in 707 of FIG. 7 when the E-mail information 3 is processed. Thereby, all the users A, B, C, D, E, F, and G, every one of which users is involved in transmission and or reception of at least any one of the E-mail information 1, the E-mail information 2, and the E-mail information 3, can commonly use all the E-mail information. In other words, in the case that the E-mail is communicated only between members who are engaged in solution of the same subject in a large organization, a member who are involved in transmission and or reception of the E-mail at least one time, namely the member who is involved in transmission and or reception of not all the E-mail, can commonly use the related E-mail information together with other members who are engaged in the same subject.

As described hereinabove, according to the present embodiment, the plurality of all the E-mail information that is grouped into a unit can be commonly used by all the addressers and addressees included in the plurality of all the E-mail information. The present embodiment is effectively used for application in which a plurality of E-mail classified according to, for example, the subject such as job or interest, is commonly used by members having the same subject. The troublesome work to change the user group that occurs very often can be omitted in the case that a plurality of E-mail information is commonly used as the grouped unit in addition to the case that the E-mail information is separately stored one by one. In detail, though the user information must be added additionally if the above-mentioned user information is to be added newly when the E-mail information is additionally registered for each group, but the complex operation can be omitted in which whether the user information of all the mail addresses included in the target E-mail information has been already registered or not is confirmed each time when one user right is set.

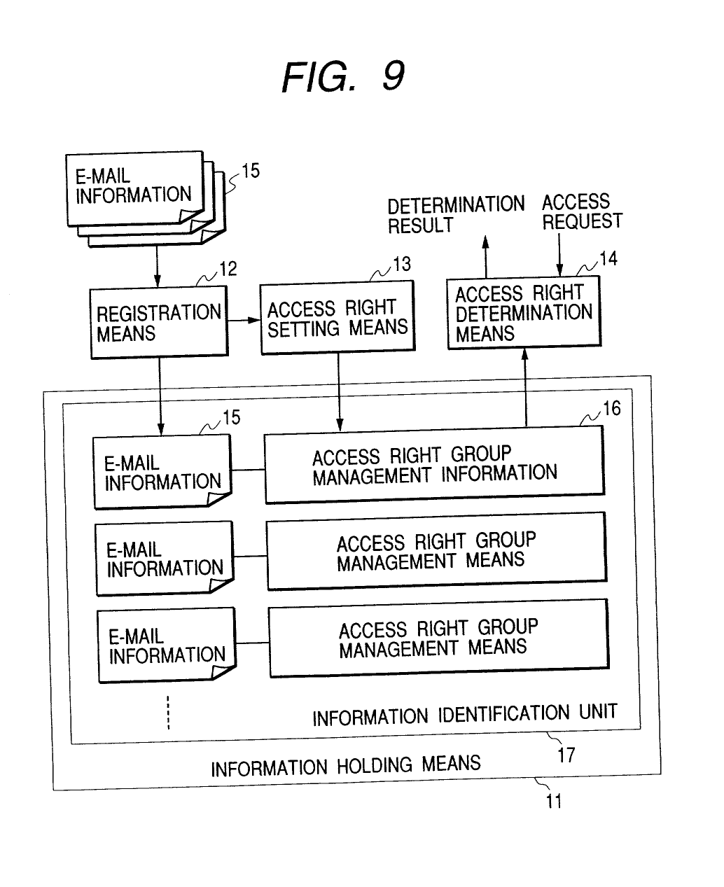

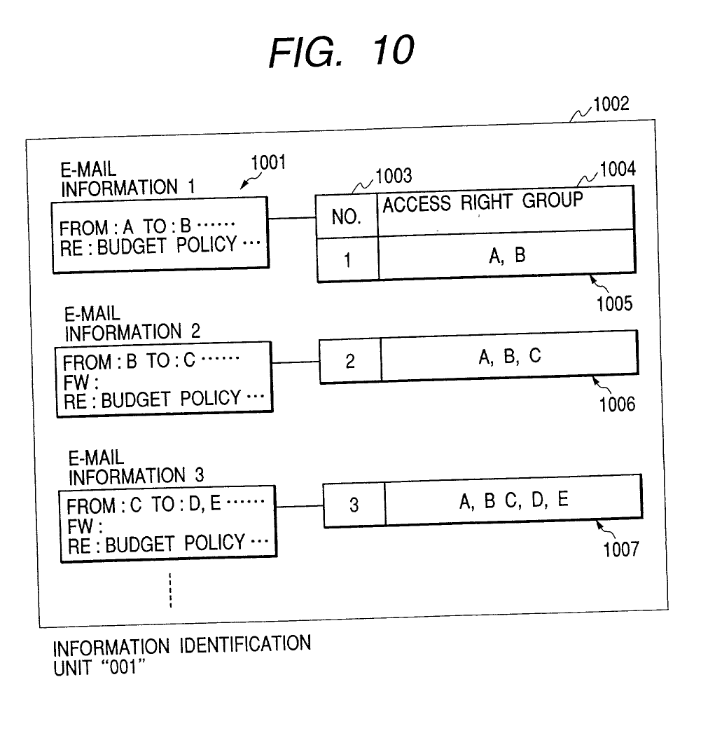

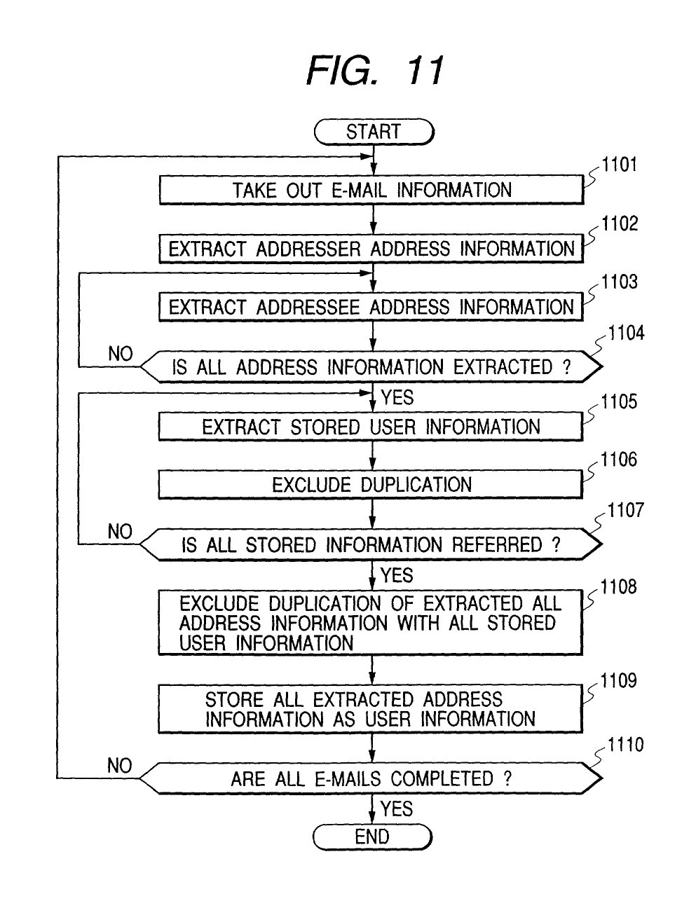

Finally, a fifth embodiment will be described hereinafter with reference to FIG. 9, FIG. 10 and FIG. 11.

In the fourth embodiment, a method is described, in which the E-mail information that is grouped in the unit of folder or the like is stored in a recording apparatus or medium, and the whole of a plurality of grouped E-mail information is used commonly. However, the high level access right setting method for controlling the access right is not described, in which the order of return and or transfer of a plurality of connected or related E-mail information is distinguished and the common range of the access right is distinguished in the sequential relation of the individual E-mail information in the case that a plurality of returned and or transferred related or connected E-mail information in the sequential relation is included in a group. In the present embodiment, an example of the access right management method for distinguish the access right in the sequential relation of the returned and or transferred E-mail that is in the connected relation will be described hereinafter.

FIG. 9 is a block diagram illustrating the system structure of the fifth embodiment of the present invention. The basic system structural components are the same as those used in the fourth embodiment. Only the different point is described. In the present embodiment, a plurality of E-mail information 15 is managed as a group in the information identification unit 17, but the access right setting unit is given for each one E-mail information. The access right group management information 16 stores the user information groups that are served for determining whether there is the right or not for each E-mail information in the information identification unit 17.

An example of the information stored in the information holding means is described with reference to FIG. 10. FIG. 10 shows a model example in which the information is stored in the information holding means 11 to which the fifth embodiment of the present invention is applied. A plurality of E-mail information shown in 1001 of FIG. 10 forms a group that includes the content of sequential relation of transmission and or reception of return and or transfer. In the example shown in FIG. 10, the E-mail information transferred from the E-mail information 1 is the E-mail information 2, and the E-mail information transferred from the E-mail information 2 is the E-mail information 3. The example in which the sequential relation of transfer arises from the E-mail information that is delivered latest is described, but the method may be applied to the case in which the transfer is repeated or the case in which return and or transfer branches from the E-mail information on the middle of the sequence.

Numeral 1002 shows an example in which a plurality of E-mail information is stored in the information identification unit 17 as one group. No. 1003 and the access right group 1004 are examples in which the information is stored on the access right group management information 16. In the example shown in FIG. 10, the identification No. of each E-mail information is stored in No.1003 and the user information for indicating whether there is the access right or not for each E-mail information in the information identification unit 17 is stored in the access right group 1004.

A routine for setting the access right concomitantly with registration of the E-mail information in the present embodiment is described with reference to FIG. 11. In the present embodiment, the registration means or program 12 registers a plurality of E-mail information every time when the registration means receives the indication that indicates the registration of the plurality of E-mail information, and the registration means or program 12 activates the access right setting means or program 13 to thereby trigger the starting of the routine shown in FIG. 11. Furthermore, the address information of the E-mail information is used as the user information of the access requester. The registration means or program 12 processes the E-mail information to be registered successively in the order of the mail number that indicates the order of occurrence of transmission and or reception.

In the present embodiment, the routine used in the case that the common use relation is set so that an addresser or an addressee of an E-mail has the access right to the E-mail transmitted and or received relatively after the above-mentioned E-mail is transmitted and or received is described as an example of common use method of the E-mail information.

At first, one E-mail information that is a target to be registered is taken out (step 1101). The taking out order is according to the mail number order that indicates the occurrence order of transmission and or reception. Next, the address information of the addresser is extracted from From: part of the header information of the taken out E-mail information 15 (step 1102). Subsequently, one address information of the addressee is extracted from To: and Cc: part of the header information of the E-mail information 15 (step 1103). Next, the step 1103 is repeated until the address information of all the addressees is extracted completely (step 1104).

Subsequently, the access right group 1004 for each of all the E-mail information (E-mail information transmitted and or received before the E-mail information to be registered currently is transmitted and or received) that has been already stored in the information identification unit 17 to be registered is referred, and the user information that has been already stored is taken out (step 1105) The duplication is excluded in the address information, namely the user information that has been stored (step 1106). The routine returns to the step 1105 and the routine is repeated until all the E-mail information that has been stored is taken out (step 1107).

Next, the duplication between all the address information of addressers and addressees taken out from the registration target E-mail information in steps 1101 to 1104 and the address information, namely the user information taken out from the access right group 1004 of the E-mail information that has been stored in steps 1105 to 1107, is excluded (step 1108). The address information collected in step 1108 is stored in the access right group 1004 of the registration target E-mail information (step 1109). The routine returns to step 1101 and the above-mentioned processing is repeated until all the registration target E-mail information is processed (in the order of occurrence of transmission and or reception) completely (step 1110).

A detailed example of processing in access right setting means or program 13 by use of the information storage example shown in FIG. 10 and the above-mentioned processing result is described herein under. In the example of three E-mail information shown in 1001 of FIG. 10, the order from the E-mail information 1 to the E-mail information 2, and the E-mail information 3 represents the sequential relation of the transmission and or reception. By applying the routine of the present embodiment to a plurality of E-mail information, the user information described herein under is stored in each access right group 1004.

At the beginning, the E-mail information 1 that has been transmitted and or received at first is processed. Thereby, the access right setting means or program 13 stores the user information “A and B”, namely the address information of addresser and or addressee of the E-mail information 1, in the access right group 1005 corresponding to the E-mail information 1. By processing the E-mail information 2 that has been transmitted and or received next, the access right setting means or program 13 combines the addresser and or addressee user “B and C” of the E-mail information 2 to the addresser and or addressee user “A and B” that has been already registered in the access right group 1005 of the E-mail information 1 and stored the combined addresser and or addressee in the access right group 1006 of the E-mail information 2. Furthermore, by processing the E-mail information 3 that has been transmitted and or received next, the access right setting means or program 13 combines the addresser and or addressee user “C, D, and E” of the E-mail information 3 to the addresser and or addressee user “A, B, and C” that has been already registered in the access right groups 1005 and 1006 of the respective E-mail information 1 and 2, and stores the combined addresser and or addressee user in the access right group 1007 of the E-mail information 3.

Subsequently, a detailed example of processing in the access right determination means or program 14 of the present embodiment is described with reference to FIG. 10. Herein, it is assumed that the users “A, B, and C” are members of budget request sections and the users “D and E” are members of budget assessment sections. In such case, the E-mail information can be used commonly so that the content of the E-mail information 1 and the E-mail information 2 that were communicated between the budget request section users for the purpose of preliminary adjustment cannot be seen by the budget assessment section users “D and E”.

As described hereinabove, according to the present embodiment, the E-mail information can be used commonly so that the E-mail information content that has been transmitted and or received before one user transmits and or receives a specified E-mail in the sequential relation of the E-mail transmission and or reception is hidden and only the E-mail information content that has been transmitted and or received after one user transmits and or receives the specified E-mail can be used commonly by the other user. As described in the detailed example, the present embodiment is effectively used in the application in which the access right is controlled so that the E-mail information content communicated for the purpose of preliminary internal adjustment is hidden from the budget assessment users in the case that E-mail is communicated between sections.

A modified example of the above-mentioned embodiment is described herein under. The address information extracted in steps 1101 to 1104 shown in FIG. 11 (without execution of steps 1105 to 1107) is stored in steps 1108 and 1109 in the access right group 1004 of each E-mail information that has been stored (the order of processing of the E-mail information is the order of occurrence of transmission and or reception). Thereby, the access right that is opposite to the above is realized. In other words, the common use is realized easily, in which the E-mail information that is transmitted and or received after one user transmits the specified E-mail cannot be used commonly but the E-mail information that was transmitted and or received before one user transmits the specified E-mail can be used commonly. The above-mentioned modified embodiment is effectively used in the case that only the specified right holders such as the superior or auditor who has received the final report examines the previous history retroactively.

As described hereinbefore, according to the present invention, because the user information that relates to transmission and or reception of the E-mail information and the access right is set, the access right is set easily to the E-mail information and the operational load for setting the right is mitigated. Because the access right is set concomitantly with registration of the E-mail information in the storage means, the access right is set correctly without mis-setting. Furthermore, because whether the registration is allowed or not is determined before registration in the storage means, the needless E-mail information is not registered. When a plurality of E-mail information is registered collectively, the access right is automatically set so that all the users who are involved in transmission and or reception of the plurality of E-mail information can use the plurality of E-mail information commonly. Furthermore, in the case a plurality of E-mail information is transmitted and or received according to connected or related transmission and or reception sequential relation, the access right of each E-mail information can be set based on the transmission and or reception sequential relation.

What is claimed is:

1. A method for managing access right of E-mail information used in a system in which the E-mail information is registered and managed in a storage means comprising the steps of:
a step in which the user information that relates to transmission and or reception is extracted from the E-mail information of registration management target; and
a step in which an access right is set to the E-mail information of the registration management target based on the user information.

2. The method for managing access right of E-mail information according to claim 1, wherein the method further comprises a step in which the E-mail information to be transmitted and or received is acquired from the E-mail system and is transferred to the storage means, and the user information that relates to the transmission and or reception is extracted from the E-mail information that has been transferred.

3. The method for managing access right of E-mail information according to claim 2, wherein the method further comprises a step in which the registration permission target information that has been defined previously before the E-mail information to be transmitted and or received is transferred to the storage means, and whether the E-mail information is registered in the storage means or not as a registration management target is determined based on the registration permission target information.

4. The method for managing access right of E-mail information according to claim 1, wherein, in the case that there are a plurality of E-mail information to be registered in the storage means, all the user information that relate to transmission and or reception of the plurality of E-mail information is extracted from the plurality of E-mail information, and the access right to the plurality of E-mail information is set based on the user information.

5. The method for managing access right of E-mail information according to claim 1, wherein, in the case that the E-mail information to be registered in the storage means is a plurality of sequentially related E-mail information transmitted and or received connectedly, the method additionally comprises a step in which sequential relation of the transmission and or reception of the plurality of E-main information is determined, and the access right of each of the plurality of E-mail information is set based on the user information that relates to the transmission and or reception extracted from the plurality of E-mail information and the sequential relation of the transmission and or reception.

6. A system for managing the access right of E-mail information in a system for registering and managing the E-mail information in a storage means comprising;
a means for extracting the user information that relates to transmission and or reception from the registration management target E-mail information, and
a means for setting the access right to the registration management target E-mail information based on the user information.

7. A recording medium that stores a program involving a method for managing the access right of the E-mail information in a system for registering and managing the E-mail information in a storage means, wherein the program comprises;
a step in which the user information that relates to transmission and or reception is extracted from the registration management target E-mail information, and
a step in which the access right is set to the registration management target E-mail information based on the user information.
